(19) United States
(12) Patent Application Publication
(10) Pub. No.: US 2025/0086848 A1
(43) Pub. Date: Mar. 13, 2025

(54) SYSTEM AND METHOD FOR SELECTING A GENERATED IMAGE THAT IS REPRESENTATIVE OF AN INCIDENT

(71) Applicant: MOTOROLA SOLUTIONS, INC., CHICAGO, IL (US)

(72) Inventors: MARIYA BONDAREVA, LOXAHATCHEE, FL (US); ROGER DAVID DONALDSON, VANCOUVER (CA); CHIA YING LEE, MEDFORD, MA (US)

(21) Appl. No.: 18/462,504

(22) Filed: Sep. 7, 2023

(51) Int. Cl. G06T 11/00; G06F 40/10

(52) U.S. Cl. CPC G06T 11/00; G06F 40/10

(57) ABSTRACT

Techniques for selecting a generated image that is representative of an incident are provided. An initial summary of an incident is generated using an artificial intelligence processing tool. At least two images based on the initial summary are generated using an artificial intelligence image generation tool. For each of the at least two images, a subsequent summary is generated using an artificial intelligence image to text generation tool. The initial summary is compared to each of the subsequent summaries. The generated image associated with the subsequent summary that is most similar to the initial summary is selected as representative of the incident.

### BACKGROUND

A Public Safety Answering Point (PSAP) is a call center that receives calls to emergency numbers (e.g. 911, 999, etc.). A call taker may receive a call, determine the nature of an incident being reported (e.g. crime, fire, medical, etc.) and cause the appropriate first responders (e.g. Police, Fire Department, Emergency Medical Services, etc.) to be dispatched to the location. During the emergency call, audio of the call may be recorded. In some cases, the audio of the call may be transcribed to produce a text version of the call. Both the audio and the transcribed text may be stored in a searchable database.

In addition, there may be additional media associated with the emergency call. With the ever increasing presence of cameras (e.g. security cameras, cellphones, body worn cameras, etc.) there may be additional video capturing the incident. Furthermore, there may be metadata associated with the call. Examples of such metadata can include time of day of the call, location of the caller, phone number of the caller, identity of the caller, etc. This additional media and metadata may be captured and stored in a database as well.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments

FIG. 1 is an example of using summaries and other multimodal input to generate candidate images for selection as representative of an incident.

FIG. 2 is an example of converting the generated images back into summaries and other multimodal output.

FIG. 3 is an example of comparing the multimodal input used to generate the images with the multimodal output to determine the similarity.

FIG. 4 is an example of selecting an image representative of the incident based on the similarity.

FIG. 5 is an example of associating the selected image with a database record of the incident.

FIG. 6 is an example of a flow chart that implements the selecting a generated image that is representative of an incident techniques described herein.

FIG. 7 is an example of a flow chart that implements determining if two incidents are closely related according to the techniques described herein.

FIG. 8 is an example of a device that may implement the selecting a generated image that is representative of an incident techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Storing all the information, such as audio, transcripts, video, and metadata, in a database allows that information to be searched and retrieved. However, it is often difficult to gain a quick understanding of the incident based on a text summary. It may be desirable to associate an image with the incident to provide a quick visual summary of the incident. Unfortunately, video of the incident is not necessarily always available. Furthermore, even when video is available, selecting an individual snapshot or picture to represent the entire incident may not be optimal. For example, in an incident where a car hits a pedestrian, an image of just the car or just the pedestrian does not accurately summarize the incident.

The techniques described herein overcome this problem by using generative artificial intelligence to provide several summaries of the incident based on a transcript of the emergency call. The summaries, along with the other data associated with the call, such as the transcript itself, the audio, any available video, and the metadata are provided to an image generating generative artificial intelligence system to generate several images representative of the incident.

It should be understood that although the techniques are described in terms of an incident that is being reported via an emergency call (e.g. 911 call), this is for purposes of ease of description rather than limitation. The techniques could be utilized with any other sources of information, such as computer aided dispatch comments, a transcript of first responder land mobile radio communications, a set of alarms from a situation awareness application, or any other sources of input related to an incident.

Generating several images representative of the incident may cause additional problems. Initially, it is known that images generated by generative artificial intelligence can sometimes suffer from what is referred to as hallucinations. An hallucination is when the image generated is somewhat unrelated, and thus not representative, of the inputs used to generate the image. In addition, even if the generated images do not include hallucinations, it is still necessary to select one image of the multiple generated images to be representative of the incident.

The techniques described herein solve this problem by using generative artificial intelligence to process each generated image to determine the inputs that might have been used to create the images. In other words, an image is presented, and the generative artificial intelligence is asked to generate a summary, audio, video, and metadata that may describe the image. In effect, the reverse of the process used to generate the images is performed. The outputs generated from the images are then compared to the inputs used to generate the images to determine the similarity between them. The more similar the generated outputs are to the actual inputs, the more likely the generated image is actually representative of the incident. The image with the most similarity may be selected as being representative of the incident.

The techniques described herein have additional uses. Once images representative of incidents have been selected, those selected images may be compared. If the images are similar, this may indicate that the incidents are related. For example, if there are two 911 calls reporting the same car accident, the images selected to represent each of those calls would likely be similar, as the inputs from each of those calls would be similar. Thus, incidents having similar representative images may be determined to be related incidents.

In a similar vein, when multiple calls about the same incident are received, the inputs from the calls may be compared to determine correspondence between the inputs from each call. The correspondence can either be similarities between the inputs or discrepancies. The correspondence (either similarity or discrepancy) may then be visualized using the techniques described above.

A method is provided. The method includes generating an initial summary of an incident using an artificial intelligence processing tool. The method further includes generating at least two images based on the initial summary using an artificial intelligence image generation tool. The method further includes generating, for each of the at least two images, a subsequent summary for each image using an artificial intelligence image to text generation tool. The method further includes comparing the initial summary to each of the subsequent summaries. The method further includes selecting the generated image associated with the subsequent summary that is most similar to the initial summary as representative of the incident.

In one aspect, the method further comprises generating the at least two images based in part on a text transcript associated with the incident. In one aspect, the method further comprises generating the at least two images based in part on audio input associated with the incident. In one aspect, the method further comprises generating the at least two images based in part on visual input associated with the incident. In one aspect, the method further comprises generating the at least two images based in part on metadata associated with the incident.

In one aspect, the method further comprises generating a second initial summary of a second incident using the artificial intelligence processing tool, generating at least two images based on the second initial summary using the artificial intelligence image generation tool, generating, for each of the at least two images based on the second incident, a second subsequent summary for each image using the artificial intelligence image to text generation tool, comparing the second initial summary to each of the second subsequent summaries, selecting the generated image associated with the second subsequent summary that is most similar to the second initial summary as representative of the second incident, comparing the selected generated image representative of the incident with the selected generated image representative of the second incident, and determining the incident and the second incident are related based on the comparing.

In one aspect, the initial summary is based on correspondence of two descriptions of the incident. In one aspect the correspondence is similarities between the two descriptions of the incident.

A system is provided. The system includes a processor and a memory coupled to the processor. The memory contains a set of instructions thereon that when executed by the processor cause the processor to generate an initial summary of an incident using an artificial intelligence processing tool. The instruction on the memory further cause the processor to generate at least two images based on the initial summary using an artificial intelligence image generation tool. The instruction on the memory further cause the processor to generate, for each of the at least two images, a subsequent summary for each image using an artificial intelligence image to text generation tool. The instruction on the memory further cause the processor to compare the initial summary to each of the subsequent summaries. The instruction on the memory further cause the processor to select the generated image associated with the subsequent summary that is most similar to the initial summary as representative of the incident.

In one aspect, the instructions further cause the processor to generate the at least two images based in part on a text transcript associated with the incident. In one aspect, the instructions further cause the processor to generate the at least two images based in part on audio input associated with the incident. In one aspect, the instructions further cause the processor to generate the at least two images based in part on visual input associated with the incident. In one aspect, the instructions further cause the processor to generate the at least two images based in part on metadata associated with the incident.

In one aspect, the instructions further cause the processor to generate a second initial summary of a second incident using the artificial intelligence processing tool, generate at least two images based on the second initial summary using the artificial intelligence image generation tool, generate, for each of the at least two images based on the second incident, a second subsequent summary for each image using the artificial intelligence image to text generation tool, compare the second initial summary to each of the second subsequent summaries, select the generated image associated with the second subsequent summary that is most similar to the second initial summary as representative of the second incident, compare the selected generated image representative of the incident with the selected generated image representative of the second incident, and determine the incident and the second incident are related based on the comparing.

A non-transitory processor readable medium containing a set of instructions thereon is provided. The instructions on the medium, that when executed by a processor cause the processor to generate an initial summary of an incident using an artificial intelligence processing tool. The instructions on the medium further cause the processor to generate at least two images based on the initial summary using an artificial intelligence image generation tool. The instructions on the medium further cause the processor to generate, for each of the at least two images, a subsequent summary for each image using an artificial intelligence image to text generation tool. The instructions on the medium further cause the processor to compare the initial summary to each of the subsequent summaries. The instructions on the medium further cause the processor to select the generated image associated with the subsequent summary that is most similar to the initial summary as representative of the incident.

In one aspect, the instructions on the medium further cause the processor to generate the at least two images based in part on a text transcript associated with the incident. In one aspect, the instructions on the medium further cause the processor to generate the at least two images based in part on audio input associated with the incident. In one aspect, the instructions on the medium further cause the processor to generate the at least two images based in part on visual input associated with the incident. In one aspect, the instructions on the medium further cause the processor to generate the at least two images based in part on metadata associated with the incident.

In one aspect, the instructions on the medium further cause the processor to generate a second initial summary of a second incident using the artificial intelligence processing tool, generate at least two images based on the second initial summary using the artificial intelligence image generation tool, generate, for each of the at least two images based on the second incident, a second subsequent summary for each image using the artificial intelligence image to text generation tool, compare the second initial summary to each of the second subsequent summaries, select the generated image associated with the second subsequent summary that is most similar to the second initial summary as representative of the second incident, compare the selected generated image representative of the incident with the selected generated image representative of the second incident, determine the incident and the second incident are related based on the comparing.

Further advantages and features consistent with this disclosure will be set forth in the following detailed description, with reference to the figures.

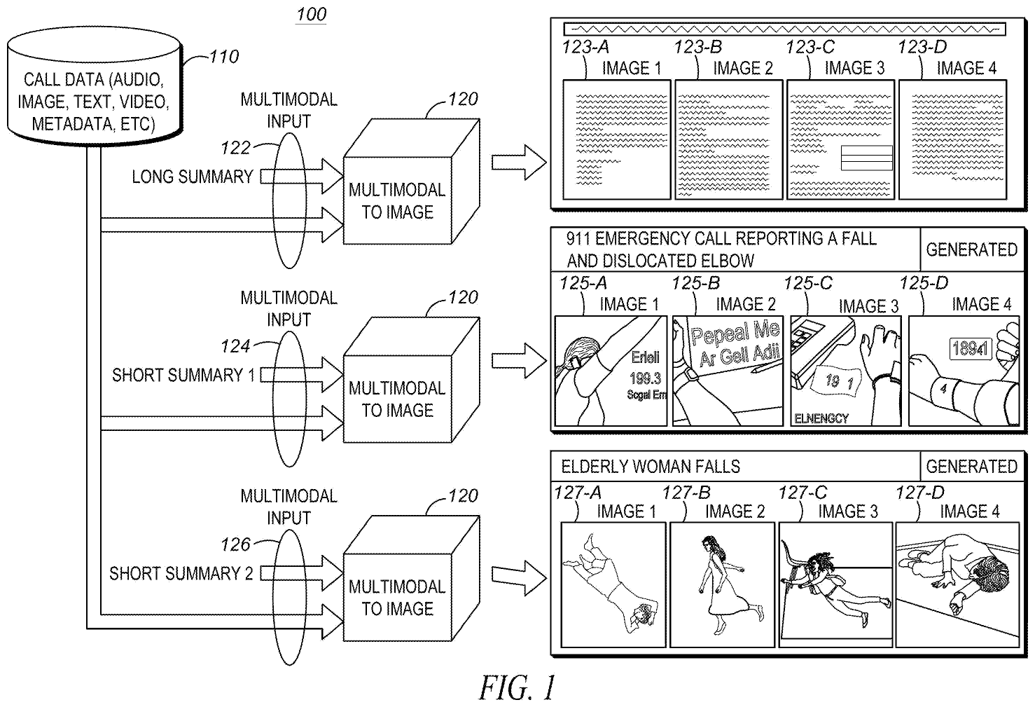

FIG. 1 is an example of using summaries and other multimodal input to generate candidate images for selection as representative of an incident. The environment 100 shown in FIG. 1 may include emergency call database 110. The emergency call database may store all information from a 911 call that is being handled. Such information can include the audio of the call itself, any video associated with the call, any metadata associated with the call, and any other type of information included in the call. For ease of description, the data included in the database may be referred to as multimodal data.

The multimodal data may also include one or more generated summaries of the emergency call. As described above, it is known to automatically transcribe an emergency call in order to convert the speech present in the call. Having a text based document may make searching the contents of the call easier because it is much more efficient to index a text document as opposed to audio. Although automatic speech to text transcription is always improving, it is not perfect.

Making matters worse is that an emergency call is not the same as other audio that is being transcribed. In normal transcription of audio, the people speaking are likely to be calm, speaking in a normal tone of voice, in a relatively quiet environment, and are not under an excessive amount of stress. The same cannot be said of a person making a call to 911. In many cases, a call to an emergency number may be coming from a person who is experiencing one of the most traumatic experiences of their lives (e.g. heart attack, fire, assault, etc.). The caller may be in a highly agitated state, may be screaming, may be highly distracted, etc.

Furthermore, depending on the nature of the incident, there may be other sounds that may affect the transcription process. For example, there may be sounds of gunshots, people screaming, sirens, etc. in the background while the person is calling 911. As such, the transcript may be difficult for a human to read and gain an understanding of the incident. For example, a transcript of an actual 911 call is presented below. The transcript has been edited to remove any identifying information.

### Begin 911 Call Transcript

Or what?
Travel.
911 what is your emergency bill?
Hello, it's now one.
I need it and then one one that's you contacted. What's going on, Sir? My wife Ziggy and this little.
What's the address there?
1-2.
Hwy. I90 Highway I90. OK, I got a few more questions for you. One moment for me, OK. Is this a good call back number for you?
123 123 1234 That's the one I've got. How old is she?
How old is she?
And our.
That's OK with the dislocated elbow. We're going to send help. OK, you said 81.
She's 81 or 7171.
Make me thank you.
She's sitting on the ground and I think, OK, let's just keep her there, OK? Do we know what causes the fall? Do we know what caused the fall?
He was out here with flowers and.
The agent offered. She fainted. Was she busy?
Google.
So just accidental. Yeah. Is there any serious bleeding?
Any serious bleeding? No bleeding.
I've lost my elbows out of joy. I understand we've got. This is just additional questions for them when they're on their thank you, OK.
Yeah, I'm still here. I'm going through all the questions you already answered. OK, when you come in the gate, there's a gate code. What's the gate code?
1234.
No stars. Is there a pound or a star?
They won the last four digits of my phone number perfect. And when you put it in the gate, you turn right and go down through the guesthouse. There's a there's a house.
Their greenhouse right there. And that's my daughter, live in her guesthouse. They turn right and go down to the door in.
Got it. Yep. I'm adding this in there. So good.
Nope, I've got a few more. OK, God question yet. But it looks like you've answered most of them. OK, answering the paramedics to help you stay on the line and say exactly what to do next. Do not move unless she is in danger. And do not split any injuries. OK. I won't move. OK. Reassure her that help is on the way. From now on. Don't let her have anything to eat or drink. It might make her sick or cause further problems. Don't move her unless it's absolutely necessary. And just tell her to be still.
Wait for help to arrive. OK. I want you to watch it very closely. If she becomes less awakened, vomits quickly lay her on her side. And before responders arrive, please put away any pets. Gather her medications or a list of them, and then have someone waved down the paramedics. OK, if she gets worse in anyway, calls back immediately for further instructions. Thank you. You're welcome. They're on their way. Bye.

### End 911 Call Transcript

As should be clear, the transcript is quite difficult to understand. Using such a transcript directly to generate images that may be representative of the incident may be problematic because in many cases the content of the transcript does not make sense due to the difficulties in transcribing the audio described above. The techniques described herein resolve this problem by using a generative artificial intelligence (AI) model to create a summary based on the transcript. It should be noted that the particular generative AI that is used is unimportant. The techniques described herein are usable with any currently available or later developed generative AI model. In the example, presented below, GPT-3.5-Turbo from OpenAI™ was used to generate the summaries. However it should be understood that any other AI model would also be suitable.

In one example implementation, there are three summaries generated for the transcript. The first may be a long summary (referred to as Long Summary). Constraints on the prompt to generate the summary may request that the summary be one paragraph long. A second summary may provide a constraint that the summary (referred to as Short Summary 1) be limited to a single sentence. A third summary may provide a constraint that the summary (referred to as Short Summary 2) be limited to a few words. It should be understood that the example of using three summaries is for ease of description only. An actual implementation may use any number of summaries. An example of the summaries produced by GPT-3.5-Turbo for each of the constraints described above is provided below.

### Long Summary

The dialogue appears to be a transcript of a 911 emergency call reporting an elderly woman, Ziggy, who fell and dislocated her elbow. The caller provides the address and phone number, as well as additional information about the fall. The 911 operator asks a series of questions to gather more details, such as the cause of the fall and whether there is any serious bleeding. The operator advises the caller not to move Ziggy unless necessary and to reassure her that help is on the way. The caller is also instructed to watch Ziggy closely and to put away any pets and gather medication information. The call ends with the operator confirming that help is on the way.

### Short Summary 1

911 Emergency Call Reporting a Fall and Dislocated Elbow

### Short Summary 2

Elderly woman falls

The system may then use a multimodal to image generative AI model 120 to take the multimodal input and generate several images based on the input. As above, the particular generative AI model used to implement the multimodal input to image generation is relatively unimportant. The techniques described are suitable for use with any currently available or later developed generative AI models. In the current example, the model used to generate the images was DALL-E, also from OpenAI™. It should be understood that any image generating AI that can receive the multimodal input and generate images that may be representative of the inputs would be suitable for use.

Each of the summaries, as well as the multimodal input from the database 110 is provided as multimodal input into a multimodal to image AI 120. For example, multimodal input 122 includes the Long Summary as well as the multimodal input from the database. Multimodal input 124 includes Short Summary 1 as well as the multimodal input from the database. Multimodal input 126 includes Short Summary 2 as well as the multimodal input from the database.

For each of these multimodal inputs 122, 124, 126 the multimodal to image 120 AI generates one or more images. In the present example, for each summary, 4 images are generated. The long summary is used to generate images 123-A . . . D, the short summary 1 is used to generate images 125-A . . . D, and the short summary 2 is used to generate images 127-A . . . D. Each of these images is a candidate for selection for the image representative of the incident.

It should be noted that in some implementations, the multi modal input may first be transformed into a textual representation prior to being used for image generation. For example, audio input could include the sound of rain falling. Rather than use the actual sound of rain, this could be converted to a text caption that says “rainy weather” which may then be used in generation of the summary. Likewise, video indicating rain could also be converted to a text caption that indicates rainy weather. What should be understood is that the multimodal data itself may be used in the image generation process or a text summary of the multimodal information may be used in the image generation process.

As shown, the images 123-A . . . D that were generated from the long summary appear mostly as textual documents. The images 125-A . . . D appear as photorealistic images. The images 127-A . . . D appear more as cartoonlike images. The details present in the images are based on the multimodal input to the multimodal to image 120 generative AI. The more detail provided, the more detailed the image, while the less detail provided, the less detailed the image.

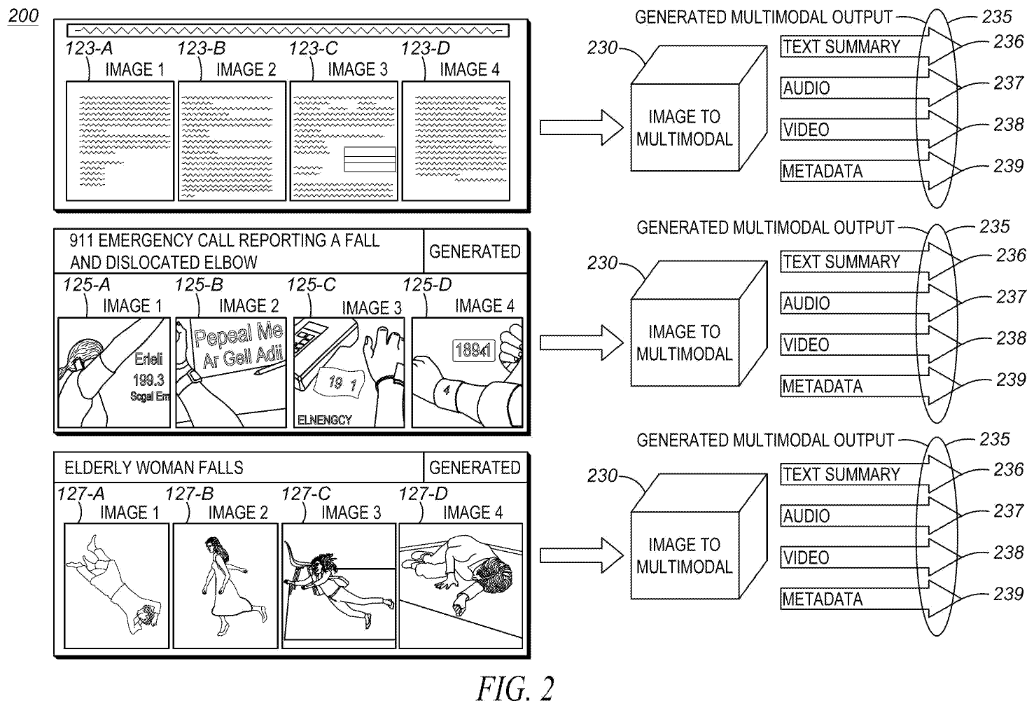

FIG. 2 is an example of converting the generated images back into summaries and other multimodal output. The environment 200 shown in FIG. 2 includes an Image to Multimodal generative AI 230. The Image to Multimodal generative AI may take as input an image. From the image, the Image to Multimodal generative AI may generate multimodal output 235 that describes the image. For example, the multimodal output 236 may include a text summary of what was depicted in the image.

The generated multimodal output 235 may also include audio 237 which would include any audio that the Image to Multimodal 230 generative AI would generate based on an input image. Similarly, the generated multimedia output would include any video 238 that the Image to Multimodal generative AI would generate based on an input image. Similarly, the generated multimedia output would include any metadata 239 that the Image to Multimodal generative AI would generate based on an input image.

What should be understood is that the process describe with respect to Multimodal to image 120 generative AI and Image to Multimodal 230 generative AI are effectively inverse processes. Given a set of multimodal inputs, the multimodal to image generative AI generates an image representative of the inputs. On the other hand, the Image to Multimodal generative AI takes as an input an image and then outputs multimodal data that would likely result in the input image. In an unrealizable ideal implementation, multimodal input used to generate an image would be exactly the same as the generated multimodal output when the image is processed to generate multimodal output.

According to the techniques described herein, each of the images 123, 125, 127 generated by the multimodal to image 120 generative AI would be processed by the image to multimodal 230 generative AI. Thus for each image, generated multimodal output would be provided.

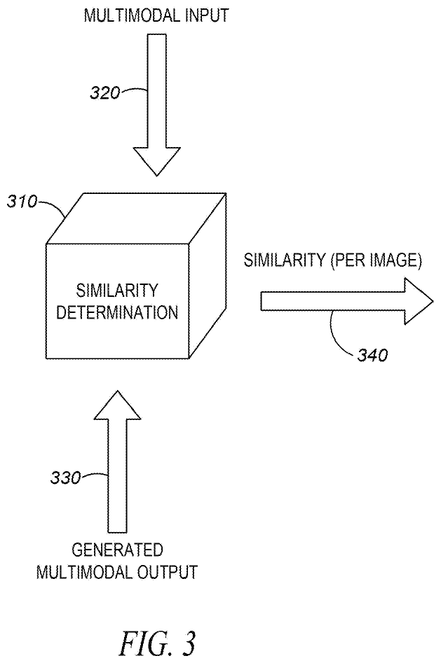

FIG. 3 is an example of comparing the multimodal input used to generate the images with the multimodal output to determine the similarity. Environment 300 includes a similarity determination 310 AI. The similarity determination AI may be used to take input, such as multimodal input 320 and determine how similar it is to other inputs, such as generated multimodal output 330.

AI capable of similarity determination is well known and the techniques described herein are not dependent on any particular similarity determination technique. Some examples of similarity determination AI are as follows.
1) Text similarity detection through embeddings. Texts 1 and 2 are mapped by a language model into a multidimensional vector space, i.e., embedded. In this space, texts with similar meaning are pointed in a similar direction. A metric, such as a cosine similarity between embeddings, can be used to decide if two texts are similar. Alternatively, a machine learning model can be trained to classify the texts as similar or different based on the embeddings.
2) Zero-short similarity detection with large language models (LLM). LLM, such as GPT-3 from OpenAI™, can make comparison of two texts: both texts are included in a prompt that asks if the texts describe the same incident or not. The output, a completion, can be a boolean value: True or False.
3) Sound similarity detection: Suppose, the background sounds are being reconstructed. For a smiling face, an audio with laughter is created. The original audio file contains an ambulance sound. Sounds can be compared with acoustic similarity algorithms that involve representations of audio in digital representations such as raw digital samples of the sound (e.g. 16 kHz RAW audio files) or mel-frequency cepstrum coefficents (MFCCs) or a neural network trained to generate similarity embeddings from digital samples. A further neural network model can infer if the sounds match based on their acoustic similarity. Alternatively, a neural network model can classify background sounds into classes. Similarity is established if sounds belong to the same class. Regardless of the method used, the laughter and ambulance sounds will be inferred not to be similar.
4) Image similarity detection. Suppose the background scenery is being reconstructed. The reconstructed image contains red and yellow trees. The call metadata suggests that the incident took place in an underground parking garage, the video shows there are no trees. Image-text matching models take image and text input simultaneously and have been trained to compute the probability that the text matches the image. If the image contains trees and the call metadata states “underground parking garage”, the matching probability is low.

Few-shot and zero-shot Large Multimodal Models (LMMs) that leverage Large Language Models (LLMs) also exist: given two images we can prompt the LMM to identify and describe similarities and differences between the reconstructed image and video frames. In some models, example image-pairs with desired text response may be provided as few-show examples for the LMM to understand the desired task.

What should be understood is that the techniques described herein are suitable for use with any currently available or later developed techniques for similarity determination.

Each of the multimodal inputs 122, 124, 126 the generated multimodal output 235 for each generated image is processed by the similarity determination 310 to determine the level of similarity 340, per image, of the generated multimodal output to the multimodal input used to create the generated image. In other words, it is determined how closely, for each image, the multimodal input is the same as the generated multimodal output. An exact match may indicate that the generated image is perfectly representative of the incident. If there is no similarity between the multimodal input and the generated multimodal output, this may indicate that the generated image is not representative of the incident and may actually be a hallucination.

Each of the multimodal inputs is compared to the generated multimodal outputs. For example, the summaries generated from the call transcript, as described above, may be compared to the generated text summaries 236 to determine how closely they align. The same similarity determination is made for the other inputs, including audio, video and metadata. The greater degree of similarity, the higher the likelihood that the image is representative of the incident.

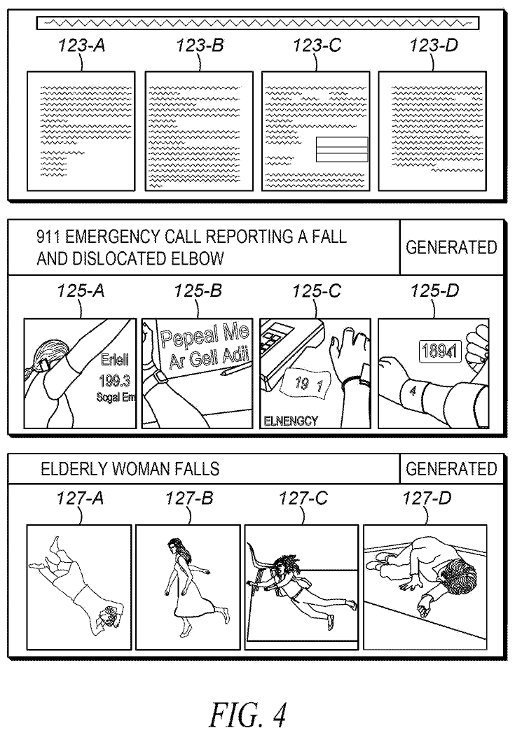

FIG. 4 is an example of selecting an image representative of the incident based on the similarity. For ease of description, the selection of the image representative of the incident described with respect to FIG. 4 is presented in terms of determining the similarity between the long summary, the short summary 1, and short summary 2, and the text summary 236. However, it should be understood that in an actual implementation, all multimodal inputs (e.g. audio, video, metadata) would also be considered.

Each image may have a text summary generated by the image to multimodal 230 generative AI. For example, the text summary for image 123-A may be “Incoherent Notes,” the text summary for image 123-B may be “Report Simulation,” the text summary for image 123-C may be “Tax declaration,” while the summary for image 123-D may be “Incoherent text.” When compared to the Long Summary described above, it is clear that the generated summaries are not very similar to the Long Summary.

The text summary for image 125-A may be “A sporting woman raises her arm,” the text summary for image 125-B may be “Project progress tracking,” the text summary for image 125-C may be “191 call,” and the text summary for image 125-D may be “Getting ready to run in the forest.” Again, as should be clear, there is very little similarity between the short summary 1 input (i.e. “911 Emergency Call Reporting a Fall and Dislocated Elbow”). Although image 125-C is close, including the correct digits in the text summary, the digits are in the incorrect order.

The text summary for image 127-A may be “A lady with 3 legs falls,” the text summary for image 127-B may be “A lady with three arms trips,” the text summary for image 127-C may be “A woman falls,” and the text summary for image 127-D may be “An old lady falls.” When compared to short summary 2 (i.e. “Elderly woman falls”) it is clear that the generated output text for images 127-C, D are semantically very similar to the input summary. The image that has the closest similarity, based on the similarity determination 310 AI may be selected as the image representative of the incident.

Although the description of FIG. 2 was presented with respect to comparison of the text summaries only it should be understood that this was for ease of description only. For example, if the multimodal input used to generate the images included audio (e.g. gunshots, people screaming, etc.) the presence of that audio in the generated multimodal output would factor into the similarity determination. For example, generated output that did not include the same audio (e.g. gunshots, people screaming, etc.) would be determined to be less similar than those that did include the audio. The same applies to both the video and metadata from the multimodal input as well. In short, the more similar the multimodal input used to generate the image is to the generated multimodal output, the higher the likelihood that the generated image is truly representative of the incident.

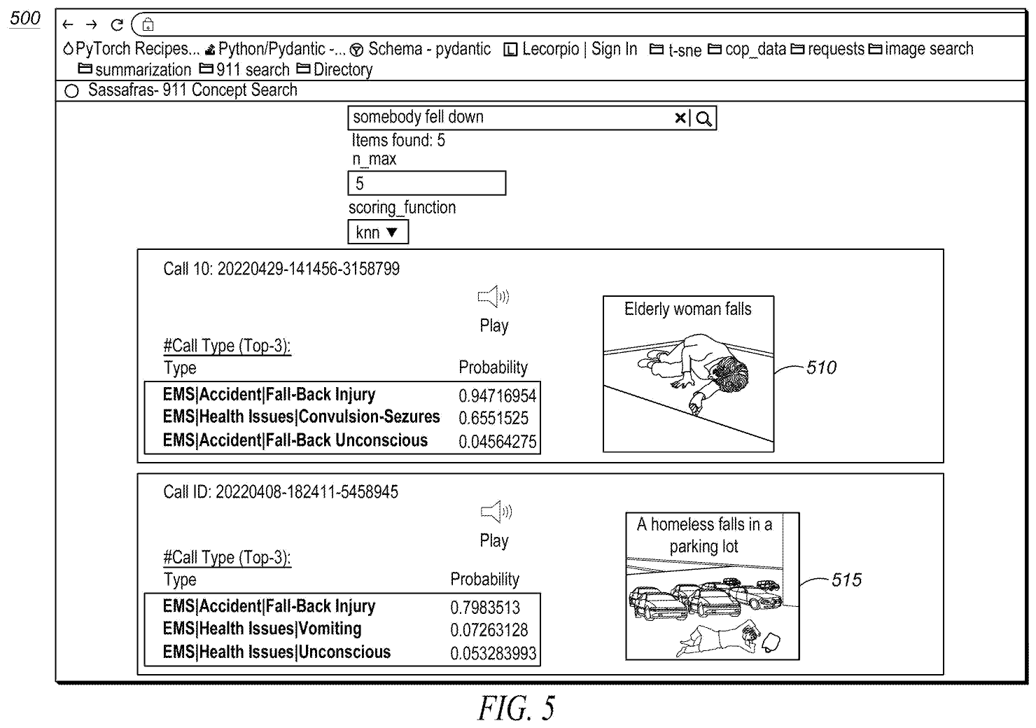

FIG. 5 is an example of associating the selected image with a database record of the incident. Once an image that is representative of an incident is selected in accordance with the techniques described above, that image may be associated with the database record corresponding to the incident. Environment 500 depicts a database screen which includes two records 510, 515. The database record 510 may be the example incident of an elderly woman who has fallen down. Database record 515 may be an incident associated with a homeless person falling down in a parking lot.

The images representative of the incident can be used when searching for an incident. For example, if the incident being searched for involves a person falling down, a search may return the two results 510, 515. From the images it is clear that one incident involves an elderly woman falling down while the other is a homeless man falling down. The images may be used to help identify which record is of interest.

Associating the images with database records may also be useful in determining if two incidents are related. For example, if there are two separate 911 calls, there may be separate records in the database. If the images determined to be representative of the respective 911 calls are very similar, this could be due to the calls having reported the same incident.

As yet another use case, when emergency calls are received that are related to the same incident, the multimodal input from each call may be compared to identify correspondence between the multimodal input. Correspondence could mean input that is the same from each call or input that is different. Once the similarities and/or differences are determined, the techniques described above may be used to generate an image that is most representative of the similarities and/or differences between the callers.

For example, if one caller reports a man standing in a parking lot and another caller reports a guy loitering in a parking lot, both calls correspond in that there is a parking lot and a man in that parking lot. An image may be generated depicting a man standing in a parking lot.

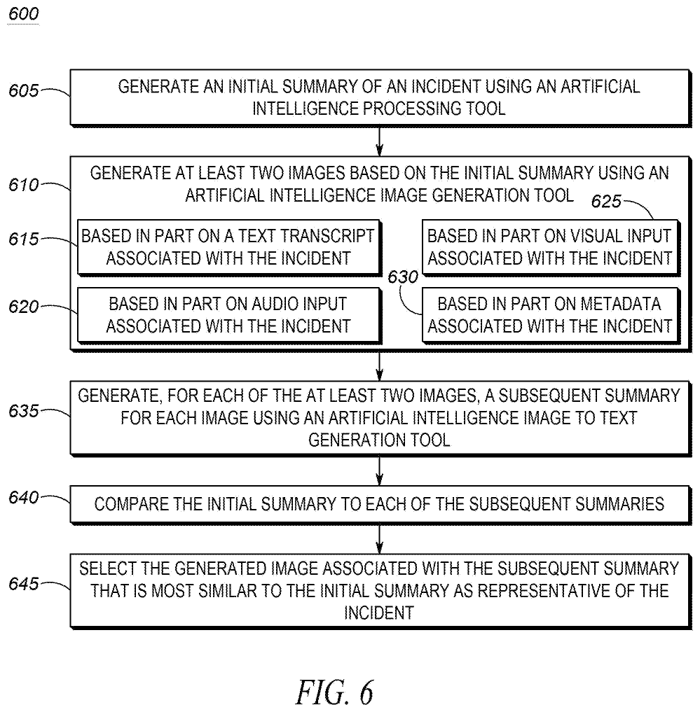

FIG. 6 is an example of a flow chart 600 that implements the selecting a generated image that is representative of an incident techniques described herein. In block 605, an initial summary of an incident may be generated using an artificial intelligence processing tool. As explained above, the initial summary may be generated by any currently available generative AI tool that is able to take in a transcript of a call, such as an emergency call, and convert the transcript into a summary. The techniques described herein are not dependent on the use of any particular generative AI tool.

In block 610, at least two images based on the initial summary may be generated using an artificial intelligence image generation tool. As explained above, the particular generative AI tool that is used is relatively unimportant. The techniques described herein are suitable for use with any currently available or later developed generative AI tools.

Generating the at least two images based on the initial summary may include using additional input, such as multimodal input. For example, in block 615, the at least two images may be generated based in part on a text transcript associated with the incident. As described above, the transcript of the emergency call may be used to generate a call summary. However, the actual input text may also be used as multimodal input to generate the at least two images.

In block 620, the at least two images may be generated based in part on audio input associated with the incident. As explained above, the emergency call may include other background sounds (e.g. gunshots, screaming, sirens, etc.) that are not sounds that would be transcribed. In some cases, the audio input may be used directly to generate the at least two images. However, in some implementations, the audio input may first be converted to a textual representation prior to being included in generation of the at least two images.

In block 625, the at least two images may be generated based in part on visual input associated with the incident. As explained above, the emergency call may include associated video (e.g. video from surveillance cameras, cell phone cameras, body worn cameras, etc.). This video input may be used as part of the process of generating the at least two images. Just as with the audio, in some implementations, the video may be directly used as multimodal input for the image generation process. In other implementations, the video itself may first be converted into a textual representation prior to being used as part of the image generation process.

In block 630, the at least two images may be generated based in part on metadata associated with the incident. As explained above, metadata may include information such as the callers geographic location, phone number, name, etc. Any other information associated with the call can be considered metadata and may be used in the process of generating the at least two images.

In block 635, for each of the at least two images, a subsequent summary for each image may be generated using an artificial intelligence image to text generation tool. It should be understood that the subsequent summary does not only include the text summary, but may also include multimodal output. As explained above with respect to FIG. 2, the image to multimodal generative AI tool 230 generates a text summary as well as multimodal (e.g. audio, video, metadata, etc.) output. It should be understood that the artificial intelligence image to text generation tool is intended to cover the functionality of the image to multimodal generative AI tool described with respect to FIG. 2.

In block 640, the initial summary is compared to each of the subsequent summaries. It should be understood that this step compares the initial summaries, as well as any additional multimodal input. For example, if the images were generated using the summaries as well as audio, video, and metadata, then the subsequent summaries would also include a text summary, audio, video, and metadata, as described with respect to FIG. 2. The comparison is of all the textual based as well as multimodal based input to create the generated images and the multimodal output generated by the image to multimodal tool.

In block 645, the generated image associated with the subsequent summary that is most similar to the initial summary may be selected as representative of the incident. As explained above, if the image to multimodal tool produces multimodal output that is very similar to the multimodal input that was used to generate the image, this is a very good indication that the image is representative of the incident and is not a hallucination. The more similar the input and output are, the more likely the image properly represents the incident.

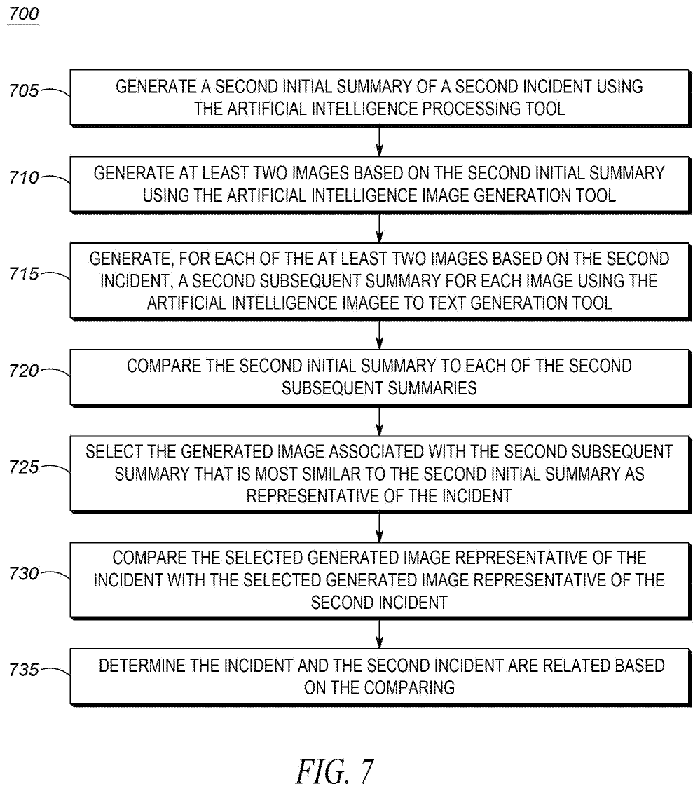

FIG. 7 is an example of a flow chart 700 that implements determining if two incidents are closely related according to the techniques described herein. The majority of the blocks in FIG. 7 are very similar to the blocks in FIG. 6, with the exception that they are being performed on multimodal input from a different emergency call.

In block 705, a second initial summary of a second incident is generated using the artificial intelligence processing tool. This block is the equivalent of block 605. In block 710, at least two images are generated based on the second initial summary using the artificial intelligence image generation tool. Block 710 is the equivalent of block 610 in FIG. 6. Although there are no equivalents to blocks 615-630 shown in block 710, it should be understood that the equivalent steps are implied in the execution of block 710. In other words, the functionality of blocks 610-630 described in FIG. 6 are intended to be represented by block 710, with the exception that it is for a different emergency call.

In block 715, for each of the at least two images based on the second incident, a second subsequent summary is generated for each image using the artificial intelligence image to text generation tool. As above, block 715 is intended to replicate the functionality of block 635, with the exception that it is for a second emergency call. In block 720, the second initial summary may be compared to each of the second subsequent summaries. This functionality is the same as that described with respect to block 640, again with the exception that it is for a second emergency call.

In block 725, the generated image associated with the second subsequent summary that is most similar to the second initial summary is selected as representative of the second incident. This is intended to be the same functionality described with respect to block 645 of FIG. 6, with the exception that it is the image selected to be representative of the second incident.

In block 730, the selected generated image representative of the incident may be compared with the selected generated image representative of the second incident. In other words, the image selected to represent each of the incident and the second incident are compared. The comparison may be done using artificial intelligence techniques similar to those used to determine the similarity of the multimodal input and the generated multimodal output.

In block 735, the incident and the second incident may be determined to be related based on the comparing. In other words, if the images that represent the incident and the second incident are sufficiently similar it may be determined that the incidents are related (e.g. may actually be two emergency calls for the same incident).

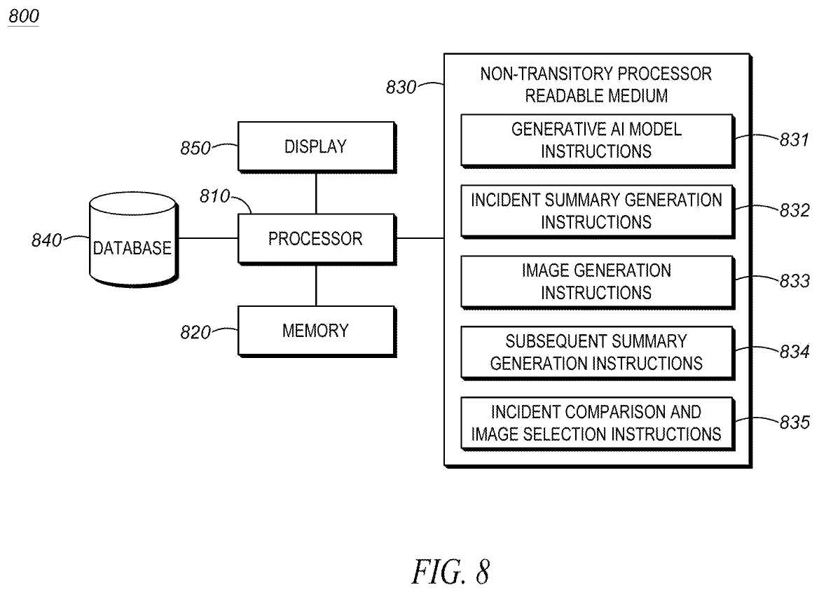

FIG. 8 is an example of a device that may implement the selecting a generated image that is representative of an incident techniques described herein. It should be understood that FIG. 8 represents one example implementation of a computing device that utilizes the techniques described herein. Although only a single processor is shown, it would be readily understood that a person of skill in the art would recognize that distributed implementations are also possible. For example, the various pieces of functionality described above (e.g. generative AI, summary generation, comparison, etc.) could be implemented on multiple devices that are communicatively coupled. FIG. 8 is not intended to imply that all the functionality described above must be implemented on a single device.

Device 800 may include processor 810, memory 820, non-transitory processor readable medium 830, database 840, and display 850.

Processor 810 may be coupled to memory 820. Memory 820 may store a set of instructions that when executed by processor 810 cause processor 810 to implement the techniques described herein. Processor 810 may cause memory 820 to load a set of processor executable instructions from non-transitory processor readable medium 830. Non-transitory processor readable medium 830 may contain a set of instructions thereon that when executed by processor 810 cause the processor to implement the various techniques described herein.

For example, medium 830 may include generative AI model instructions 831. The generative AI model instructions 831 may cause the processor to execute the various trained generative AI models described herein. As noted throughout this description, the techniques described herein are not limited to any particular trained generative AI model, and any currently available or later developed models would be suitable for use. Operation of the trained generative AI models is utilized in the other instructions described below.

The medium 830 may include incident summary generation instructions 832. Using the generative AI model instructions 832, the incident summary generation instructions 832 may create incident summaries. Those summaries may take as input text transcripts, audio, video, metadata, and any other available information. Such input may be provided by the database 840. The incident summary generation instructions 832 have been described throughout the specification generally, including places such as blocks 605 and 705.

The medium 830 may include image generation instructions 833. The image generation instructions 833 may cause the processor to use the generative AI model instructions 831 to generate images based on the summaries. The image generation instructions 833 are described generally throughout the specification, including places such as blocks 610-630, and 710.

The medium 830 may include subsequent summary generation instructions 834. The subsequent summary generation instructions 834 may utilize the generative AI model instructions 831 to generate subsequent summaries for each of the generated images. The subsequent summary generation instructions 834 are described generally throughout the specification, including places such as blocks 635 and 720.

The medium 830 may include incident comparison and image selection instructions 835. The incident comparison and image selection instructions 835 may cause the processor to compare the initial incident summaries and the subsequent incident summaries to identify those that are the most similar. The image associated with the summaries that are the most similar may be selected as the image representative of the incident. Images from different summaries may be compared to identify associated incidents. The results and the selected image may be stored in the database 840. The selected image may also be displayed via a display (e.g. computer monitor, etc.) 850. The incident comparison and image selection instructions 835 are described generally throughout the specification, including places such as blocks 640, 645, and 720-735.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot implement a trained generative AI, among other features and functions set forth herein).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
generating an initial summary of an incident using an artificial intelligence processing tool;
generating at least two images based on the initial summary using an artificial intelligence image generation tool;
generating, for each of the at least two images, a subsequent summary for each image using an artificial intelligence image to text generation tool;
comparing the initial summary to each of the subsequent summaries; and
selecting the generated image associated with the subsequent summary that is most similar to the initial summary as representative of the incident.

2. The method of claim 1 further comprising:
generating the at least two images based in part on a text transcript associated with the incident.

3. The method of claim 1 further comprising:
generating the at least two images based in part on audio input associated with the incident.

4. The method of claim 1 further comprising:
generating the at least two images based in part on visual input associated with the incident.

5. The method of claim 1 further comprising:
generating the at least two images based in part on metadata associated with the incident.

6. The method of claim 1 further comprising:
generating a second initial summary of a second incident using the artificial intelligence processing tool;
generating at least two images based on the second initial summary using the artificial intelligence image generation tool;
generating, for each of the at least two images based on the second incident, a second subsequent summary for each image using the artificial intelligence image to text generation tool;
comparing the second initial summary to each of the second subsequent summaries;
selecting the generated image associated with the second subsequent summary that is most similar to the second initial summary as representative of the second incident;
comparing the selected generated image representative of the incident with the selected generated image representative of the second incident; and
determining the incident and the second incident are related based on the comparing.

7. The method of claim 1 wherein the initial summary is based on correspondence of two descriptions of the incident.

8. The method of claim 7 wherein the correspondence is similarities between the two descriptions of the incident.

9. A system comprising:
a processor; and
a memory containing a set of instructions thereon that when executed by the processor cause the processor to:
generate an initial summary of an incident using an artificial intelligence processing tool;
generate at least two images based on the initial summary using an artificial intelligence image generation tool;
generate, for each of the at least two images, a subsequent summary for each image using an artificial intelligence image to text generation tool;
compare the initial summary to each of the subsequent summaries; and
select the generated image associated with the subsequent summary that is most similar to the initial summary as representative of the incident.

10. The system of claim 9 further comprising instructions to:
generate the at least two images based in part on a text transcript associated with the incident.

11. The system of claim 9 further comprising instructions to:
generate the at least two images based in part on audio input associated with the incident.

12. The system of claim 9 further comprising instructions to:
generate the at least two images based in part on visual input associated with the incident.

13. The system of claim 9 further comprising instructions to:
generate the at least two images based in part on metadata associated with the incident.

14. The system of claim 9 further comprising instructions to:
generate a second initial summary of a second incident using the artificial intelligence processing tool;
generate at least two images based on the second initial summary using the artificial intelligence image generation tool;
generate, for each of the at least two images based on the second incident, a second subsequent summary for each image using the artificial intelligence image to text generation tool;
compare the second initial summary to each of the second subsequent summaries;
select the generated image associated with the second subsequent summary that is most similar to the second initial summary as representative of the second incident;
compare the selected generated image representative of the incident with the selected generated image representative of the second incident; and
determine the incident and the second incident are related based on the comparing.

15. A non-transitory processor readable medium containing a set of instructions thereon that when executed by a processor cause the processor to:
generate an initial summary of an incident using an artificial intelligence processing tool;
generate at least two images based on the initial summary using an artificial intelligence image generation tool;
generate, for each of the at least two images, a subsequent summary for each image using an artificial intelligence image to text generation tool;
compare the initial summary to each of the subsequent summaries; and
select the generated image associated with the subsequent summary that is most similar to the initial summary as representative of the incident.

16. The medium of claim 15 further comprising instructions to:
generate the at least two images based in part on a text transcript associated with the incident.

17. The medium of claim 15 further comprising instructions to:
generate the at least two images based in part on audio input associated with the incident.

18. The medium of claim 15 further comprising instructions to:
generate the at least two images based in part on visual input associated with the incident.

19. The medium of claim 15 further comprising instructions to:
generate the at least two images based in part on metadata associated with the incident.

20. The medium of claim 15 further comprising instructions to:
generate a second initial summary of a second incident using the artificial intelligence processing tool;
generate at least two images based on the second initial summary using the artificial intelligence image generation tool;
generate, for each of the at least two images based on the second incident, a second subsequent summary for each image using the artificial intelligence image to text generation tool;
compare the second initial summary to each of the second subsequent summaries;
select the generated image associated with the second subsequent summary that is most similar to the second initial summary as representative of the second incident;
compare the selected generated image representative of the incident with the selected generated image representative of the second incident; and
determine the incident and the second incident are related based on the comparing.
